(19) United States
(12) Patent Application Publication
(10) Pub. No.: US 2007/0229417 A1
(43) Pub. Date: Oct. 4, 2007

(54) Flexible Display Device

(75) Inventors: Andrea Giraldo, Eindhoven (NL); Mark Thomas Johnson, Eindhoven (NL); Eliav Itzhak Haskal, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,712

(22) PCT Filed: May 4, 2005
(86) PCT No.: PCT/IB05/51457

§ 371 Date: Nov. 6, 2006

(30) Foreign Application Priority Data
May 11, 2004 (EP) 04102021.5

(51) Int. Cl. G09G 3/32

(52) U.S. Cl. 345/82

(57) ABSTRACT

Complementary transistors e.g. a p-channel TFT-transistor (16) and an n-channel TFT-transistor (17) are used as driving transistors in a pixel circuit (10). Upon bending they vary in opposite ways, one with smaller (drain) current the other with larger (drain) current, and in total the effect will be reduced.

The invention relates to flexible electronic devices and in particular to a display device comprising on a flexible substrate at least one picture element and a display driver device, comprising at least a first driving transistor of a first conductivity kind in series with the picture element.

Such display devices are increasingly based on electro luminescence -based semi conducting organic materials, also known as light emitting diodes (polyLEDs or OLEDs). The display devices may either exhibit luminescence via segmented pixels (or fixed patterns) but also a display by means of a matrix pattern is possible. In many applications nowadays, like laptop computers and organizers (but of course also in GSM telephones) portable (display) devices are preferred. To this end more and more flexible (display) panel devices are used.

In flexible (active matrix) display devices the bending or rolling affects the performance of the thin film transistors in the pixel circuits and in the internal drivers. Since many displays have pixel elements that are current driven (for example OLED displays), a variation of current will lead to a worsening of the image quality. This also applies to other flexible electronic circuits.

It is, inter alia, an object of the present invention to provide a display device of the type described in the opening paragraph in which worsening of the image quality (or of the circuit performance in general) is prevented. To this end in a display device according to the invention the display driver comprises at least a first driving transistor of a first conductivity kind in series with the picture element in a first current path and at least a second driving transistor of a second opposite conductivity kind in series with the picture element in a second current path parallel to the first current path. Worsening of the image is prevented by the fact that that p-channel transistors after bending in one direction exhibit a smaller drain current while n-channel transistors exhibit a larger drain current. If the bending/rolling occurs in a direction opposite to said first direction the effect is opposite. The drain current in p-channel transistors is larger while in n-channel transistors the drain current is smaller. The invention makes use of this effect, which is known per se from a SID2003 Conference publication (Conf. Proc. SID2003-28.2).

In a preferred embodiment the operation of the first and second current path is controlled by two data signal lines controlling the driving transistors of the first and the second conductivity kind. The controlling connections of the driving transistors for instance are coupled to the data signal lines via further switching elements.

Such an embodiment may comprise a further control switching element parallel to the picture element, the further switching element and the control switching element having the same addressing line as control lines. By choosing this approach transistor (source) voltages of the first conductivity kind will be less sensitive to time dependent behavior of the light emitting diodes and of transistors of the second conductivity kind.

In a further embodiment the further switching elements have separate addressing lines as control lines, for instance subsequent addressing lines.

In yet a further embodiment a further control switching element comprises a transistor of the first conductivity kind in series with a transistor of the second conductivity kind. The series arrangement of the transistors also advantageously uses the fact that that p-channel transistors after bending in one direction exhibit a smaller drain current while n-channel transistors exhibit a larger drain current.

These and other aspects of the invention are apparent from and will be elucidated with reference to the embodiments described hereinafter.

In the drawings:

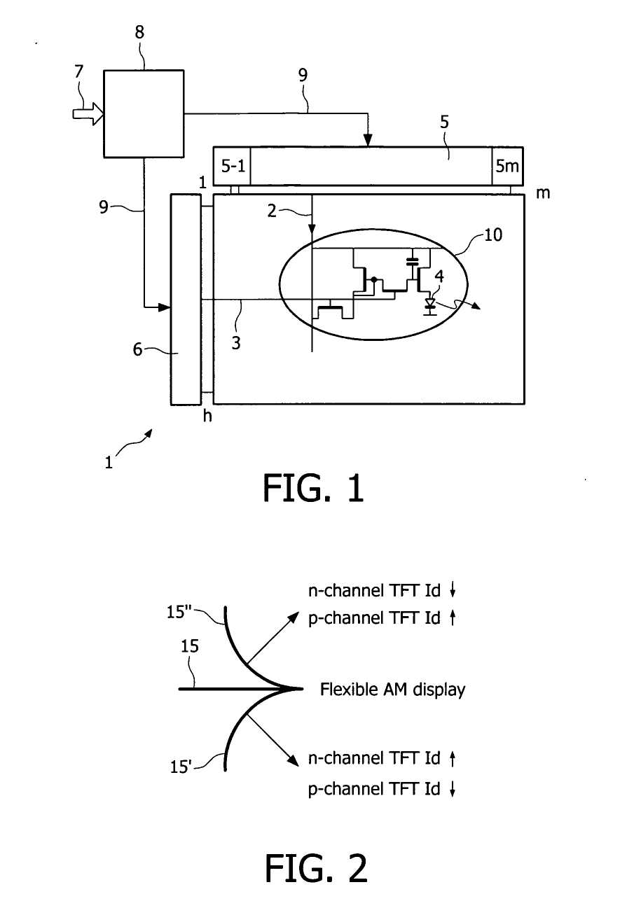

FIG. 1 shows diagrammatically a display device, in which the invention is used,

FIG. 2 shows transistor characteristics of transistors used in flexible displays,

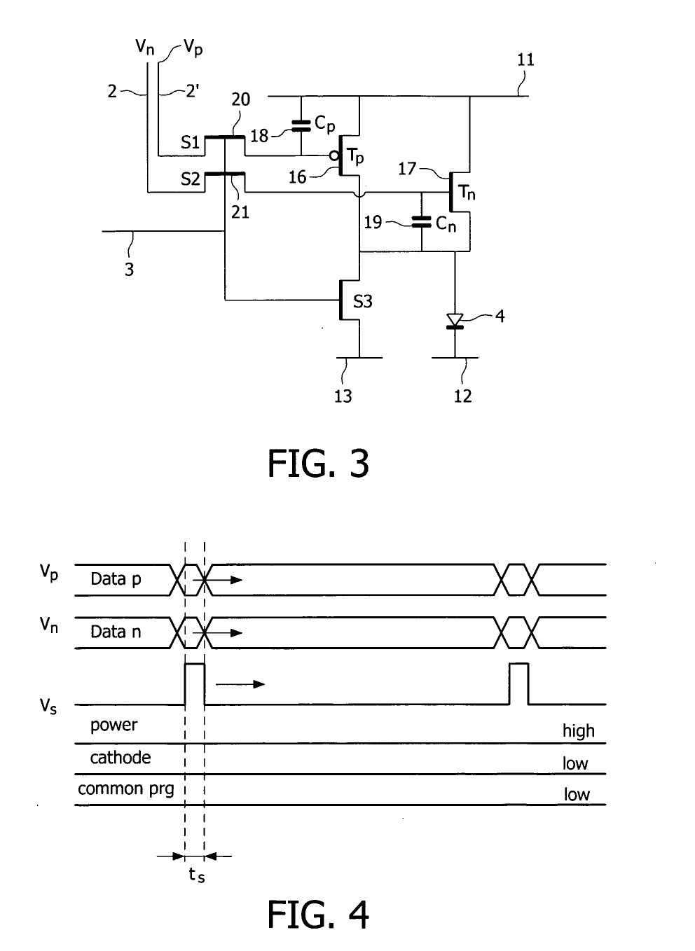

FIG. 3 shows a first embodiment of a display driver device according to the invention,

FIG. 4 shows a driving scheme for the embodiment of FIG. 3,

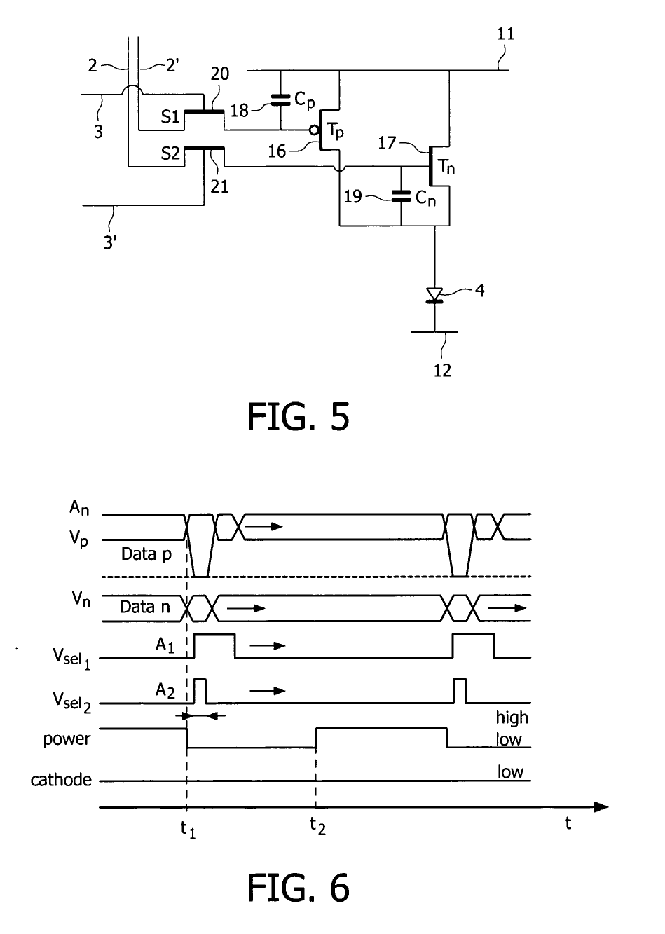

FIG. 5 shows a further embodiment of a display driver device according to the invention,

FIG. 6 shows a driving scheme for the embodiment of FIG. 5, while

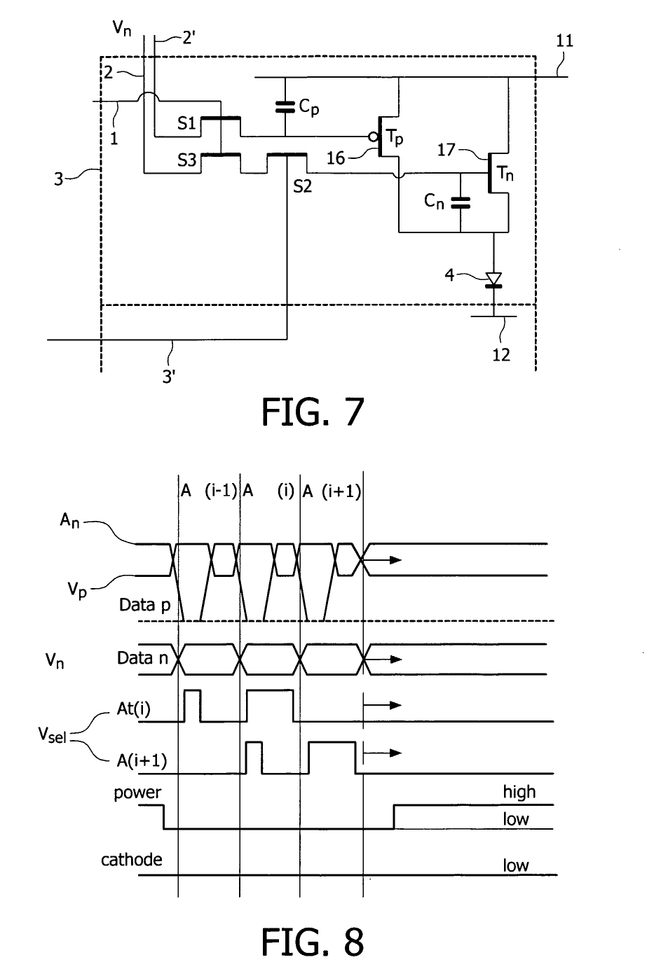

FIG. 7 shows another embodiment of a display driver device according to the invention and

FIG. 8 shows a driving scheme for the embodiment of FIG. 7

The Figures are diagrammatic and not to scale; corresponding components are generally denoted by the same reference numerals.

FIG. 1 shows diagrammatically an equivalent circuit diagram of a part of a display device 1 according to the invention. This display device comprises a matrix of (P) LEDs or (0) LEDs 4 with n rows (1, 2, . . . , n) and m columns (1, 2, . . . , m). In FIG. 1 only one (0) LEDs and its accompanying driving circuit is shown. The display device further comprises a row selection circuit or row driver 6 and a data register or data driver 5. Externally presented information 7, for example, a video signal, is processed in a processing unit 8 which, dependent on the information to be displayed, charges the separate parts 5-1, . . . , 5-m of the data register 5 via lines 9.

The selection of a row takes place by means of the row selection circuit 6 via the selection lines 3, in this example by providing them with the required selection voltages.

Writing data takes place in that, during selection, the driving circuit 10, for instance a current switch, is switched on by means of the data register 5, for example via switching elements. The value of the current is determined by the contents of the data register and is supplied to the LEDs 4 via data lines 2.

The driving circuit 10 may be of a simple type comprising just one driving transistor and one selection transistor (switch). As explained in the introduction, in flexible display devices the bending or rolling affects the performance of the thin film transistors in the pixel circuits and in the internal drivers. FIG. 2 shows bending of a substrate 15′ in one direction. Now p-channel transistors exhibit a smaller drain current while n-channel transistors exhibit a larger drain current than in the flat position 15. If the bending/rolling occurs in the opposite direction (shown as substrate 15″) the effect is opposite: the drain current in p-channel transistors is larger while in n-channel transistors it is smaller.

FIG. 3 shows a driving circuit 10 according to the invention having two driving transistors of opposite polarity (conductivity type) as shown in FIG. 3, in this example a p-channel transistor 16 (transistor Tp) and an n-channel transistor 17 (Tn). Here a voltage programmable driving circuit is shown. Two capacitors 18, 19 are attached between the gates and the sources of the transistors 16, 17. Two signals (Data n (Vₙ) and Data p (Vₚ)) are stored on these capacitors from two data lines 2, 2′ through two selection transistors 20, 21 (switching elements S1, S2), which are enabled by a row selection signal presented on selection line 3. The two driving transistors are both driving current to the OLED 4 and opposite variations in the current upon bending are cancelled/reduced.

The waveforms used for the addressing of the pixel (OLED 4) are shown in FIG. 4. The power voltage (presented on voltage line 11), the cathode voltage (presented on voltage line 12), and the common voltage (presented on voltage line 13) are common voltages for all pixels OLED 4. Typically the power voltage is high (e.g. 10V) and the cathode voltage and the common voltage are low (e.g. ground).

In order to address properly the transistor Tn in this example an additional switching element 22 (S3) is used. This switching element is enabled by the selection line 3 and brings the source of Tn at the common voltage. During the addressing, indicated by (double-arrow) tₛₑₜ the voltage between the gate and the source of Tn is equal to V_{Datan}-V_{common}. This voltage defines the amount of current flowing from Tn to the OLED. This approach is chosen because otherwise the source voltage of Tn will be sensitive to the variations in time of the OLED and variations in time of Tp. If the OLED and Tp are stable in time, switching element 22 (S3) may be deleted. Now in general variations in the drain current in n-channel transistors δ_{d,n} are compensated by variations in the drain current in p-channel transistors δ_{d,p}, which a are about equal or δI_{d,n}˜−δI_{d,p} and therefore δI_{OLED}˜0.

FIG. 5 shows a second embodiment using another pixel circuit, while in FIG. 6 the corresponding waveforms are shown. In this pixel circuit the switching element S3 and the common voltage (presented on voltage line 13) of FIG. 3 have been deleted, which is beneficial since the aperture of the pixel is increased. In order to cope with the variations of OLED and Tp (as described above) a pulsing power is now used. To this end an additional row selection line 3′ has been inserted.

In this embodiment first the V_{GS} voltage of n-channel transistor 17 (Tn) is set at t₁ (see FIG. 6) by lowering the power voltage on voltage line 11 and by applying a voltage Aₙ to the gate of p-channel transistor 16 (transistor Tp) in order to open it almost as a switching element. In this way the voltage at the source of n-channel transistor 17 (transistor Tn) is almost equal to the power voltage and the voltage on the gate can be safely written on the capacitor 19 (Cn). Since the power voltage is low (preferable at ground as the cathode), no current is flowing to the OLED 4 yet. Then p-channel transistor 16 (transistor Tp) is programmed by writing Data p (Vₚ, data line 2′) on the gate of p-channel transistor 16 (transistor Tp).

Preferably, in this embodiment, all pixel circuits are addressed row at a time with power line 11 low value and then the power line 11 is brought high at t₂, after all lines 3,3′ have been selected, to drive all OLEDs 4 within a row. As in the first example, during bending δI_{d,n}˜−δI_{d,p} and therefore δI_{OLED}˜0.

In the embodiment of FIGS. 7 the switching element S2 of the pixel circuit in line i is enabled by the selection row 3′ (selection signal Al) of each following line (i+1), see FIG. 8. In this way the additional row selection line has been removed and the aperture of the pixel is increased. Since each selection line 3 now has a double function, viz. controlling the first switching element S1 of the next or (dependent on the order of addressing) the previous row and then switching elements S2 and S3 of the row it belongs to, two subsequent selection signals are applied to the selection line 3 (see waveforms in FIG. 8). In this way an additional row selection line has been removed; although an additional control switch is added the aperture of the pixel nevertheless is increased.

The invention is not restricted to the embodiments shown. As mentioned in the introduction also a series arrangement of a p-type transistor and an n-type transistor also advantageously uses the fact that that p-channel transistors after bending in one direction exhibit a smaller drain current while n-channel transistors exhibit a larger drain current. So in principle some or all transistors in the embodiment shown can be replaced by such a series arrangement, although this requires extra driving signals. This and the other aspects of the invention also apply to other flexible electronic circuits.

The invention resides in each and every novel characteristic feature and each and every combination of features. Reference numerals in the claims do not limit the protective scope of these claims. The use of the verb “to comprise” and its conjugations does not exclude the presence of elements other than those stated in the claims. The use of the article “a” or “an” preceding an element does not exclude the presence of a plurality of such elements.

1. A display device (1) comprising on a flexible substrate at least one picture element (4) and a display driver device comprising at least a first driving transistor (16) of a first conductivity kind in series with the picture element in a first current path, the display driver device comprising at least a second driving transistor (17) of a second opposite conductivity kind in series with the picture element in a second current path parallel to the first current path.

2. A display device as claimed in claim 1 in which the operation of the first and second current path is controlled by two data signal lines (2) controlling the driving transistors of the first and the second conductivity kind.

3. A display device as claimed in claim 2 the controlling connections of the driving transistors (16, 17) being coupled to the data signal lines via further switching elements (20, 21).

4. A display device as claimed in claim 3 having a further control switching element (S3) parallel to the picture element, the further switching elements (20, 21) and the control switching element having the same addressing line (3) as control lines.

5. A display device as claimed in claim 2, the further switching elements (20, 21) having separate addressing lines (3) as control lines.

6. A display device as claimed in claim 5, the further switching elements (20, 21) having subsequent addressing lines (3) as control lines.

7. A display device as claimed in claim 2, a further switching element comprising a transistor of the first conductivity kind in series with a transistor of the second conductivity kind.

8. A display device as claimed in claim 2 the driving transistors being field effect transistors, the gate connection being the controlling connections.

9. An electronic device comprising on a flexible substrate at least a first transistor of a first conductivity kind in a first current path, the electronic driver device comprising at least a second opposite conductivity transistor of a second kind in a second current path parallel to the first current path and controlling circuitry to control the first and second transistor.

10. An electronic device as claimed in claim 9 further comprising an electrical branch having a transistor of the first conductivity kind in series with a transistor of the second conductivity kind.

11. An electronic device as claimed in claim 11 the transistors being field effect transistors.

12. A handheld device comprising a electronic device as claimed in claim 9.
